(19) United States
(12) Patent Application Publication
(10) Pub. No.: US 2009/0249949 A1
(43) Pub. Date: Oct. 8, 2009

(54) METHODS AND DEVICES FOR BUBBLE MITIGATION

(75) Inventors: John Kepler, Lexington, MA (US); Alexander Watson, Gloucester, MA (US)

Correspondence Address: COOLEY GODWARD KRONISH LLP;ATTN: Patent Group, Suite 1100, 777 - 6th Street, NW, WASHINGTON, DC, 20001, US

(73) Assignee: Helicos BioSciences Corporation, Cambridge, MA (US)

(21) Appl. No.: 12/397,870

(22) Filed: Mar. 4, 2009

Related U.S. Application Data
(60) Provisional application No. 61/034,140, filed on Mar. 5, 2008.

(51) Int. Cl. B01D 19/02; B01D 53/22

(52) U.S. Cl. 95/44; 95/155; 96/6

(57) ABSTRACT

The invention relates to methods, systems and devices for mitigation of bubbles in a micro-fluidic environment. For example, the invention relates to methods, systems and devices for mitigation of bubbles from reagents, solvents, formulations and for improving chemical reactions in micro-fluidic systems, such as for fluorescence detection and polynucleotide sequencing.

### RELATED APPLICATIONS

This application claims the benefit of and priority to U.S. provisional application No. 61/034,140, filed Mar. 5, 2008, the entirety of which is hereby incorporated herein by reference for all purposes.

### FIELD OF THE INVENTION

The invention generally relates to methods, systems and devices for mitigation of bubbles in a micro-fluidic environment. More particularly, the invention relates to methods, systems and devices for mitigation of bubbles from reagents, solvents, formulations and for improving chemical reactions in micro-fluidic systems, such as for fluorescence detection and polynucleotide sequencing.

### BACKGROUND OF THE INVENTION

Recently, methods and apparatus for analyzing polynucleotide sequences have been developed. See, e.g., U.S. Pat. No. 7,282,337; U.S. Pat. No. 7,279,563; U.S. Pat. No. 7,226,720; U.S. Pat. No. 7,220,549; U.S. Pat. No. 7,169,560; U.S. Pat. No. 6,818,395; U.S. Pat. No. 6,911,345; US Pub. Nos. 2006/0252077; 2007/0070349; and 2007-0070349. These automated methods and apparatus provide for high speed and high throughput analysis of long polynucleotide sequences with simplicity, flexibility and lower cost. See, e.g., www.helicosbio.com/, particularly information on HeliScope™ Sequencer (e.g., www.helicosbio.com/Products/HelicosGeneticAnalysissystem/HeliScopetradeSequencer/tabid/8 7/Default.aspx website visited as of Mar. 5, 2008).

In such methods and apparatus, and other related or unrelated micro-fluidic devices or environments, it is sometimes critical to have undesirable bubbles or gasses removed from the operating fluids within the systems, such as from reagents, buffers, solvents, etc. In general, in micro-fluidic devices bubbles are a source of major problems, from inconsistent chemistry to imaging problems and mechanical blockages. Inaccurate metering of fluids or materials can degrade the precision and accuracy of measurements. Gas bubbles can also interfere with the chemical or physical properties or performance of the micro-fluidic system. Thus, it is highly desirable that micro-fluidic devices, such as employed in the automated polynucleotide sequencers, bubbles from reagents, formulations and other fluids within the operating system are reduced, minimized or eliminated.

### SUMMARY OF THE INVENTION

The invention is based, in part, on the discovery that degassing using gas-permeable tubing (e.g., in-line degassing) contained in a vacuum chamber or a vacuumed sheath (or encase) can effectively achieve the desired objective of reduction, minimizing or elimination of bubbles in the down-stream micro-fluidic device (for example, the flow cell in a polynucleotide sequencer).

In one aspect, the invention generally relates to a method for mitigating or preventing bubbles in a micro-fluidic environment. The method includes the steps of (a) degassing one or more of source reagents prior to mixing of the source reagents; and (b) degassing the mixed reagents prior to introducing the mixed reagents into the micro-fluidic environment. In some embodiments of the invention, the micro-fluidic environment is or comprises a flow cell, such as a flow cell for the sequencing of a polynucleotide as found in an apparatus or system for single molecular sequencing of DNAs, RNAs or other poly- or oligo-nucleotides. The source reagents may include 2, 3, 4, 5, 6, 7, 8 or more different reagents. Degassing may be achieved by passing source fluids to be degassed through a gas-permeable tubing from which gas present in the passing fluid is removed from the fluid via the gas-permeable tubing and into a vacuumed chamber or space. The gas-permeable tubing may be stationed in an vacuumed chamber. In a preferred embodiment, the gas-permeable tubing is encased in an vacuumed sheath that encases the tubing along the length of the gas-permeable portion.

In another aspect, the invention generally relates to an apparatus that includes a micro-fluidic device fluidly connected to an in-line degas system prior to the entrance of source reagents or mixtures thereof into the micro-fluidic device. In some embodiments of the invention, the micro-fluidic environment is or comprises a flow cell, such as a flow cell for the sequencing of a polynucleotide as found in an apparatus or system for single molecular sequencing of DNA, RNA or other poly- or oligo-nucleotides. The source reagents may include 2, 3, 4, 5, 6, 7, 8 or more different Teagents. Degassing may be achieved by passing source fluids to be degassed through a gas-permeable tubing from which gas present in the passing fluid is removed from the fluid via the gas-permeable tubing and into a vacuumed chamber or space. The gas-permeable tubing may be stationed in an vacuumed chamber. In a preferred embodiment, the gas-permeable tubing is encased in an vacuumed sheath that encases the tubing along the length of the gas-permeable portion.

In another aspect, the invention generally relates to a method for improving chemical reaction in a micro-fluidic environment. The method includes removing bubbles from pre-mixed reagents and mixed reagents prior to the mixed reagents entering the micro-fluidic environment.

The foregoing aspects and embodiments of the invention may be more fully understood by reference to the following figures, detailed description and claims.

### BRIEF DESCRIPTION OF THE DRAWINGS

The invention may be further understood from the following figures in which:

FIG. 1 is a schematic illustration of an embodiment of a sequencing apparatus.

FIG. 2A is a schematic illustration of an embodiment of a sequencing apparatus having at least one in-line degassing system incorporated therein.

FIG. 2B is a schematic illustration of an embodiment of an in-line degassing system coupled to a micro-fluidic device.

FIG. 3 is a schematic illustration of an embodiment of an in-line degassing system.

FIG. 4A is a schematic illustration of an embodiment of an in-line degassing systems.

FIG. 4B is a schematic illustration of an embodiment of an in-line degassing systems.

### DETAILED DESCRIPTION OF THE INVENTION

In its simplest sense, the invention relates to in-line degassing using gas-permeable tubing contained in a vacuum chamber or a vacuumed sheath (or encase) so as to effectively achieve the desired objective of reduction, minimizing or elimination of bubbles in the down-stream micro-fluidic device (for example, the flow cell in a polynucleotide sequencer). The invention relates to both the application of hardware to the described solution of the presented problem of bubble mitigation in micro-fluidic devices and a specific application technique to help eliminate bubbles from micro-fluidic devices.

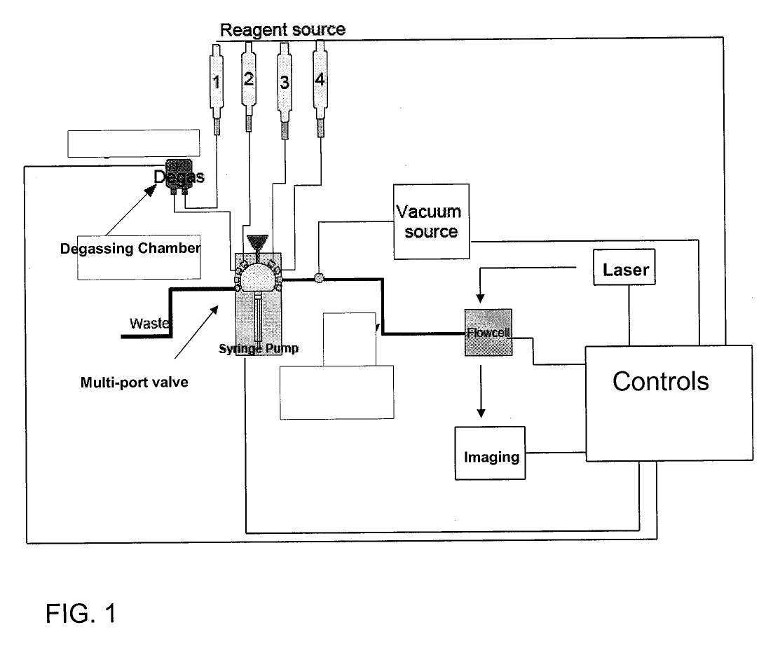

For example, as illustrated in FIG. 1, is a schematic diagram of an embodiment of a sequencing apparatus. The apparatus includes a plurality of reagents and/or buffer lines that are fluidly connected to a multi-port valve and/or a mixing chamber which output mixed solutions of the desired combination of reagents to the down stream flow cell where reactions and/or detection or imaging take place as designed.

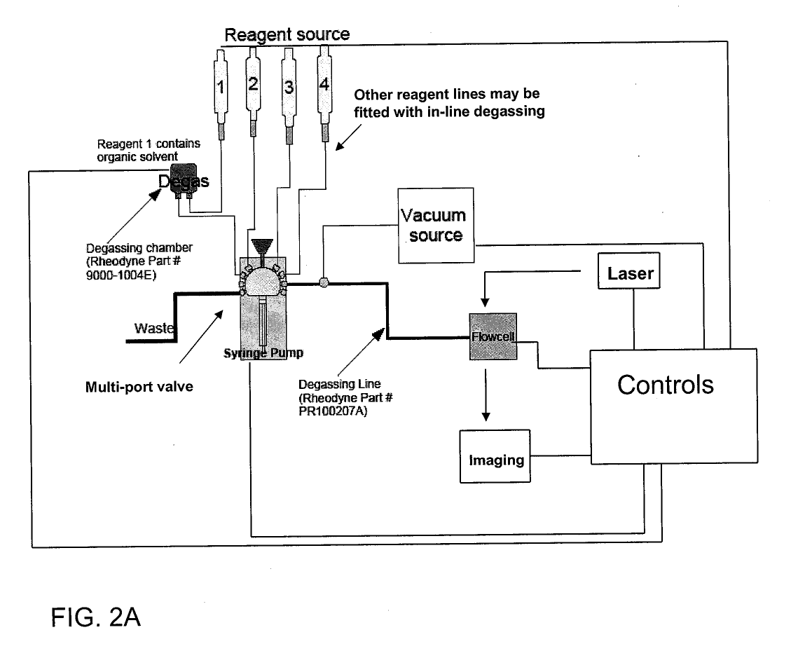

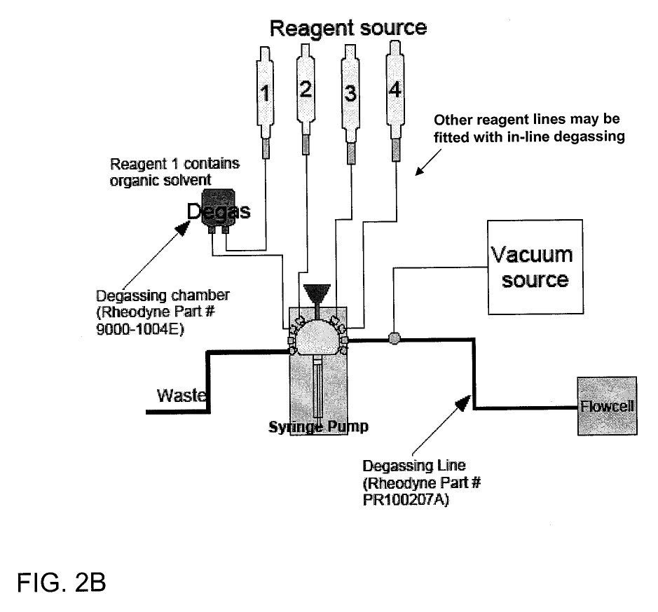

In an improved system wherein an embodiment of the invention is employed, as schematically illustrated in FIG. 2A, in-line degassing using gas-permeable tubing contained in a vacuum chamber or, preferably a vacuumed sheath (or encase) is used to reduce, minimize or eliminate bubbles before the down-stream receiving micro-fluidic device (for example, the flow cell in a polynucleotide sequencer). For example, in FIG. 2A, each of the incoming lines to the multi-port valve may be fitted with such in-line degassing tubing (along with appropriate vacuumed chamber or sheath). In addition, the outgoing line from the multi-port valve to the flow cell may also be fitted with such in-line degassing tubing (e.g., along the full length or substantially along the full length of the connection line). In another example, as schematically illustrated in FIG. 2B, four lines from four reagent sources are directed to a syringe pump and mixed before directed to the flow cell. A degassing line coupled to a vacuum source can be incorporated so as to subject the exiting mixture from the mixer to in-line degassing as the liquid travels to the flow cell.

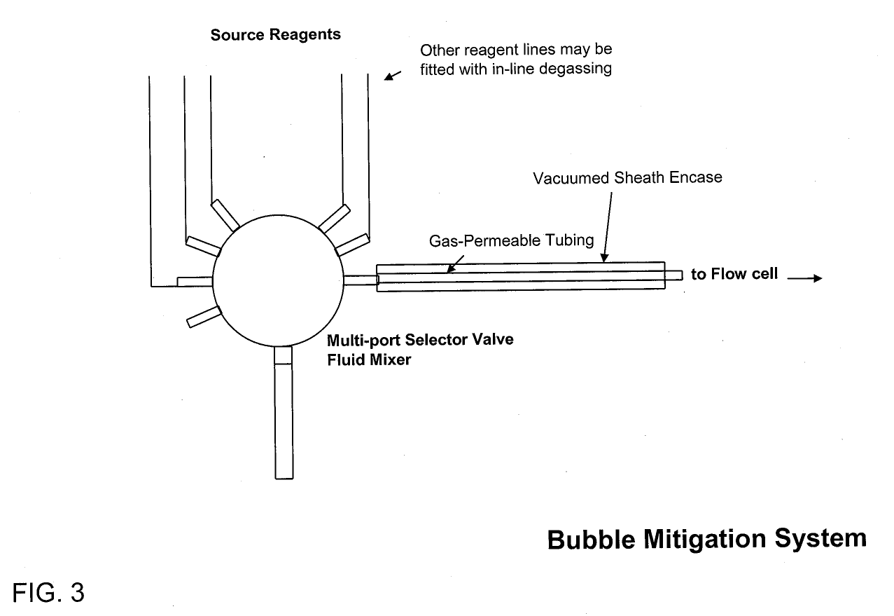

In a more general embodiment of the invention, as schematically illustrated in FIG. 3, an in-line degassing system includes a plurality of incoming lines to a fluid mixer, wherein one or more of the incoming lines (e.g., all incoming lines) to the fluid mixer are fitted with the degassing tubing along with the corresponding vacuumed chamber or sheath. Alternative to, optionally or in addition to the above, the outgoing line from the fluid mixer to the down stream receiving micro-fluidic device is fitted with the degassing tubing along with the corresponding vacuumed chamber or sheath.

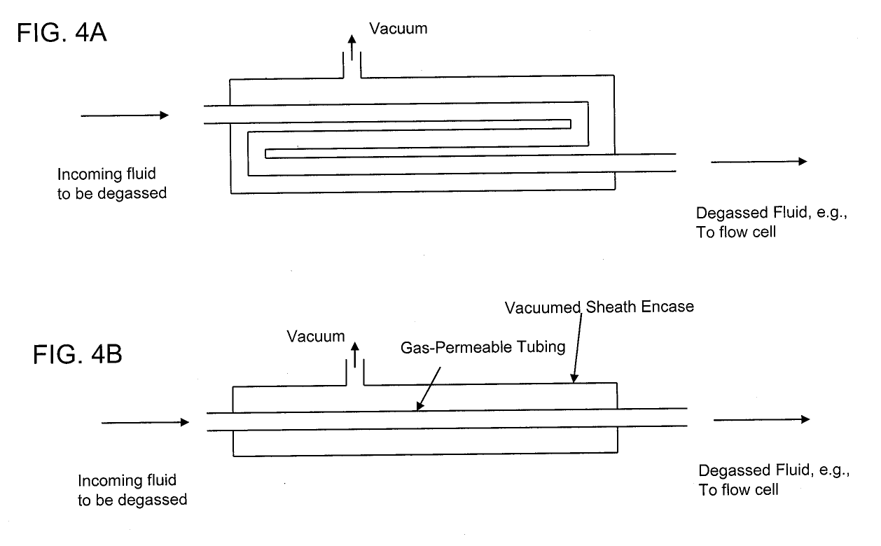

Some embodiments of the degassing system of the invention are schematically illustrated in FIG. 4A and FIG. 4B, wherein a tubing of gas-permeable material is encased in a vacuum chamber (FIG. 4A) or preferably in an encased sheath along the length of the gas permeable tubing (FIG. 4B). A pump source is connected to the degassing line to create pressure differential and to remove gasses of the bubbles. The gas-permeable tubing lets gas pass through at pressure differentiation but does not allow liquid fluids to permeate the tubing.

In one embodiment of the invention, as schematically illustrated in FIG. 2B, the first step in removal of bubbles from a closed chemistry system is to purge a first small amount of a reaction formulation directly to waste, not through the micro-fluidic device. This eliminates any bubbles at the top of the syringe pump that are created by the mixing process or by the increase in density which can occur in the mixing of organic chemicals and inorganic chemicals.

In one example, the in-line degassing system used in an automatic polynucleotide sequencer or analyzer consists of a coiled tube made of gas permeable material contained inside a vacuum chamber. As the fluid flows through the tube the dissolved gasses are removed. This technique can be used to remove excess gasses from organic solvents prior to their being mixed into a reagent formulation (e.g., the vacuum chamber is in line between the solvent bottle and the input to the liquid handling system such as a mixer). This minimizes the out-gassing that results when organic solvents, which can hold many times more gas than water, are mixed with water. A similar chamber has been used on the output of the system in-line with and before the micro-fluidic device (e.g., a flow cell).

In another embodiment of the bubble removal system, a gas permeable tube is contained in a sheath along its length (e.g., Rheodyne Part #PR100207A). It is the space between the tubing and the sheath that is evacuated in this case. The length of tubing is used as the output from the automated liquid system to the micro-fluidic device. This works by removing dissolved gasses from the final reagent formulation as it is pumped into the flow cell, thus significantly reducing any out-gassing that may occur at changes in pressure or temperature anywhere in the path to and through the flow cell. The in-line version advantages include: no increase in swept volume and decrease of cost of reagents. The system also significantly reduces dispersion as the liquids are moved into the flow cell since it has a much smaller internal diameter.

This has been shown to reduce the occurrence of bubbles in the flow cell from 6% of fluid transfers to less than 0.2% and probably better.

One application of the invention, its technique and related hardware, is its use in a sequencing system, e.g., the HeliScope™ Single Molecule Sequencer (Helicos BioSciences Corporation of Cambridge, Mass.) for automated creation of formulations on the fly for single molecule sequencing. To achieve its breakthrough performance, the sequencer incorporates a number of advanced technologies and innovative engineering solutions:

Touch Screen Monitor & Graphical User Interface: A touch screen monitor allows the user to interact with the instrument's simple and flexible workflow driven interface to define and monitor a run.

Integrated Barcode Readers: The system has integrated barcode readers to assist in proper loading and tracking single molecule sequencing reagents and flow cells.

Remote Web Tool: A web based tool allows the user remote access and monitoring capabilities to the system to define runs, download data and obtain run status from runs that are in progress.

Precision Flow Cell: The instrument performs sequencing reactions inside two precision flow cells. Alternating between the two, it performs sequencing reactions in one while capturing images from the other. The flow cells use a proprietary surface chemistry to capture single molecules at a density of 100 million strands of DNA per square centimeter. The current flow cell configuration contains 25 discrete channels, enabling the analysis of up to 50 individual or multiplexed samples per run.

Fluid Delivery System: To maintain reagent integrity and optimize performance across the duration of a single molecule sequencing experiment, an advanced fluid delivery system provides just-in-time reagent mixing and delivery to the flow cells.

High Speed Precision Stage: To capture images from the single molecule sequencing reaction, the instrument incorporates a high speed, thermally-controlled stage for accurate, repeatable positioning during the imaging process.

System Monitoring: The sequencer provides real time monitoring and alert capabilities of the system environment—including reagent level sensing, temperature, pressure and other critical operating parameters. All metrics are recorded to a run log file for QC and traceability.

System UPS: The instrument contains its own uninterruptible power supplies capable of allowing the instrument to reach a “safe” stopping point in the sequencing-by-synthesis process.

### Incorporation By Reference

The entire disclosure of each of the publications and patent documents referred to herein is incorporated by reference in its entirety for all purposes to the same extent as if each individual publication or patent document were so individually denoted.

### Equivalents

The invention may be embodied in other specific forms without departure from the spirit or essential characteristics thereof. The foregoing embodiments are therefore to be considered in all respects illustrative rather than limiting on the invention described herein. Scope of the invention is thus indicated by the appended claims rather than by the foregoing description, and all changes that come within the meaning and range of equivalency of the claims are intended to be embraced therein.

What is claimed is:

1. A method for mitigating or preventing bubbles in a micro-fluidic environment, comprising
(a) degassing one or more of source reagents prior to mixing of the source reagents; and
(b) degassing the mixed reagents prior to introducing the mixed reagents into the micro-fluidic environment.

2. The method of claim 1, wherein the micro-fluidic environment is a flow cell.

3. The method of claim 2, wherein the micro-fluidic environment is a flow cell for the sequencing of a polynucleotide.

4. The method of claim 1, wherein the source reagents comprise 2, 3, 4, 5, 6, 7, or 8 different source reagents.

5. The method of claim 1 wherein degassing is achieved by passing source fluid to be degassed through a gas-permeable tubing from which gas present in the passing fluid is removed from the fluid through the gas-permeable tubing into a vacuumed chamber or space.

6. The method of claim 5, wherein the gas-permeable tubing is stationed in a vacuumed chamber.

7. The method of claim 5, wherein the gas-permeable tubing is encased in a vacuumed sheath that encases the gas-permeable tubing along the length of the gas-permeable portion.

8. An apparatus comprising a degassing system performing a method of any of claims 1-7.

9. An apparatus comprising a micro-fluidic device coupled to an in-line degas system prior to the entrance of source reagents or mixtures thereof into the micro-fluidic device.

10. The apparatus of claim 9, wherein the micro-fluidic device comprises a flow cell.

11. The apparatus of claim 10, wherein the micro-fluidic device comprises a flow cell for the sequencing of a polynucleotide.

12. The apparatus of claim 9, wherein the source reagents comprise 2, 3, 4, 5, 6, 7, or 8 different source reagents.

13. The apparatus of claim 9 wherein degassing is achieved by passing source fluid to be degassed through a gas-permeable tubing from which gas present in the passing fluid is removed from the fluid through the gas-permeable tubing into a vacuumed chamber or space.

14. The apparatus of claim 13, wherein the gas-permeable tubing is stationed in a vacuumed chamber.

15. The apparatus of claim 13, wherein the gas-permeable tubing is encased in a vacuumed sheath that encases the gas-permeable tubing along the length of the gas-permeable portion.

16. A method for improving a chemical reaction in a micro-fluidic environment, comprising removing bubbles from pre-mixed reagents or mixed reagents prior to the pre-mixed or mixed reagents entering the micro-fluidic environment.

17. The method of claim 16, comprising using any method or apparatus of any of claims 1-15.

18. The method of claim 16, comprising removing bubbles from the pre-mixed reagents and the mixed reagents prior to the mixed reagents entering the micro-fluidic environment.

19. The method of claim 16, comprising removing bubbles from the mixed reagents prior to such mixed reagents entering the micro-fluidic environment along substantially the full length of the connecting line between reagent mixing and a micro-fluidic chemical system.
